(19) United States
(12) Patent Application Publication
(10) Pub. No.: US 2022/0097639 A1
(43) Pub. Date: Mar. 31, 2022

(54) Bioshield

(71) Applicant: Patrick McClymont, Stone Mountain, GA (US)

(72) Inventor: Patrick McClymont, Stone Mountain, GA (US)

(21) Appl. No.: 17/038,926

(22) Filed: Sep. 30, 2020

(51) Int. Cl. B60R 21/02

(52) U.S. Cl. CPC B60R 21/026

(57) ABSTRACT

The present invention is a portable partition for conveniently shielding users from bodily fluids particulate. In particular, the invention allows a user to create a partition in unique manner to help mitigate the spread of pathogens. The proposed embodiment provides a unique experience for a user by providing a pleasant and most importantly a safe experience.

### CROSS-REFERENCE TO RELATED APPLICATIONS

None.

### BACKGROUND OF THE INVENTION

The problem of open-air virus transmission while traveling in a private or commercial vehicle can be mitigated by utilizing a portable partition that can be installed in automobiles.

### Field of the Art

The subject disclosure relates to a portable vinyl partition for mitigating exposure to passengers and drivers from viral contamination while occupying a vehicle. More particularly, the present disclosure relates to novel method of mitigating the spread of contagions.

With air being the largest medium for microbial contamination that exists, protective coverings such as portable partitions in vehicles are crucial.

### Discussion of the State of the Art

The spread of viruses can be detrimental on society, especially where the virus can spread through air and touch. The burden of dealing with viruses can have an impact on travelers especially where patrons rely on transportation that cause them to travel in small spaces such as automobiles. Generally, ride share companies such as app driving platforms can present a particular risk of viruses. Where patrons have to sit in the rear of such vehicles the risk of contamination can be high. For instance, on any given day, thousands of people are moving around in downtown New York city for pleasure or business and utilizing app driving platforms for transportation; this can pose a dangerous risk for the public. Just being an occupant in a commercial vehicle can raise the possibility of both the driver and or patrons becoming ill due to exposure during a ride. Combine this example with the number of vehicles and people that travel in every major U.S. city then this can cause an increase of deadly health concerns such as the recent COVID-19 outbreak. To elaborate, most ride service vehicles are manufactured with an open-air design that allow the transmission of germs and viruses to flow throughout the compartment of the vehicle. These vehicles are not equipped with any specially designed partition between the front and rear portions of the compartment where patrons sit. This is a concern for both the driver and patrons because viral contamination can freely move between the front and rear compartments of the vehicle as a result of the dose proximity and communication between the parties. Previously the only resemblance of a partition between the front and rear seats were often available in police vehicles where a cage was used. These types of barriers were used primarily for containing arrested individuals and provided no protection for the spread of viruses due to open conversations or coughing. Accordingly, what is needed in the art is a novel manner to help mitigate the spread of viruses and assisting with preventing the general public from becoming ill due to viral contamination in public spaces. What is further needed in the art is a novel invention that will greatly assist a user in sealing a significant portion a vehicle in a way to help mitigate deadly viruses from spreading. The proposed embodiment is further ideal because its ultimate purpose is to allow for an easy isolation process to help minimize the exposure to the public from such contaminations in a manner that will be a welcoming change for patrons.

### SUMMARY OF THE INVENTION

Accordingly, the inventor has conceived, in a preferred embodiment of the invention, a portable vinyl partition that can be installed in various sized vehicles.

According to a preferred embodiment of the invention, is a vinyl-partition that can be modified and retrofitted for various sized vehicles which allows the user to conveniently insert a partition between the front and rear seats in a novel manner. What is further disclosed is a partition that securely fits along the internal pillars (18) along the interior of the vehicle in a manner that mitigates bodily fluids particulates. What is further disclosed is a vinyl partition that includes a surface that forms a center with an outer foam that forms the outer perimeter of the embodiment to make a secure contact with the interior walls of the vehicle that provides a partition between the front and rear portions of the vehicle, thus sealing off a significant portion of the vehicle's compartment The surface and the exposed frame structure are key components of the invention in that the combination of these features work to create what is referred to as a portable vinyl partition between the front and rear compartments of the vehicle.

### BRIEF DESCRIPTION OF THE DRAWING FIGURES

The accompanying drawings illustrate several embodiments of the invention and, together with the description, serve to explain the principles of the invention according to the embodiments. It will be appreciated by one skilled in the art that the particular embodiments illustrated in the drawings are merely exemplary and are not to be considered as limiting of the scope of the invention or the claims herein in any way.

FIG. 1 is a perspective left-side angle view from a vehicle's rear seat of a portable vinyl partition, according to a preferred embodiment of the invention.

FIG. 2 is a perspective perpendicular view from a vehicle's rear seat of a portable partition for conveniently forming a partition, according to a preferred embodiment of the invention;

FIG. 3 is a perspective right-side angle view from a vehicle's rear seat of a portable partition for conveniently forming a partition, according to a preferred embodiment of the invention.

### DETAILED DESCRIPTION

The inventor has conceived, an embodiment that mitigates the spread of bodily fluid particulates while occupying a vehicle.

The terms “a” or “an”, as used herein, are defined as one, or more than one. The term “plurality”, as used herein, is defined as two, or more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

Reference throughout this document to “one embodiment”, “certain embodiments”, “an exemplary embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation.

Reference throughout this document to “attachment straps”, “strap”, “belts”, “straps” or similar terms refers to an extension of material that is used to position the embodiment around the inner objects of a vehicle in a manner to secure the apparatus to the vehicle's compartment. Thus, the appearances of such phrases or in various places throughout this specification are not necessarily all referring to the same embodiment. Furthermore, the particular features, structures, or characteristics may be combined in any suitable manner in one or more embodiments without limitation.

Reference throughout this document to “inlet opening”, “inlet”, “pocket” or similar terms refers to the area of the partition that includes an aperture along the center portion of the partition. The inlet is considered the area of the partition where a user can position the inlet to receive existing vents, storage trays etc. once the partition is installed. Since most vehicles can standard with vents or ash trays, the Bioshield will be designed with precut inlets to allow the vents to be accessible by a passenger. This area will generally be designed to allow a passenger to utilize features such vents and ashtrays that will be designed for rear seat passengers. Thus, the appearances of such phrases or in various places throughout this specification are not necessarily all referring to the same embodiment. Furthermore, the particular features, structures, or characteristics may be combined in any suitable manner in one or more embodiments without limitation.

Reference throughout this document to “frame structure”, “frame” or similar terms refers to a structure that extends along the outer and lateral portion of the embodiment to provide rigidity for installation. The frame is considered the skeletal support structure of the outer perimeter of the partition that will brace against the internal compartment surface of the vehicle. Additionally, the frame structure extends along the body in a contiguous fashion and through an orifice of the foam to provide rigidity while applying pressure to the internal surface of the vehicle. The frame will generally be tightly clutched between what is referred to as the left and right-side interior of the vehicle. Some portions of the embodiment allow for the frame structure to be exposed while the peripheral areas are designed with the frame structure encased in foam material. Thus, the appearances of such phrases or in various places throughout this specification are not necessarily all referring to the same embodiment. Furthermore, the particular features, structures, or characteristics may be combined in any suitable manner in one or more embodiments without limitation.

One or more different inventions may be described in the present application. Further, for one or more of the inventions described herein, numerous alternative embodiments may be described; it should be appreciated that these are presented for illustrative purposes only and are not limiting of the inventions contained herein or the claims presented herein in any way. One or more of the inventions may be widely applicable to numerous embodiments, as may be readily apparent from the disclosure. In general, embodiments are described in sufficient detail to enable those skilled in the art to practice one or more of the inventions, and it should be appreciated that other embodiments may be utilized and that structural changes may be made without departing from the scope of the particular inventions. Accordingly, one skilled in the art will recognize that one or more of the inventions may be practiced with various modifications and alterations. Particular features of one or more of the inventions described herein may be described with reference to one or more particular embodiments or figures that form a part of the present disclosure, and in which are shown, by way of illustration, specific embodiments of one or more of the inventions. It should be appreciated, however, that such features are not limited to usage in the one or more particular embodiments or figures with reference to which they are described. The present disclosure is neither a literal description of all embodiments of one or more of the inventions nor a listing of features of one or more of the inventions that must be present in all embodiments.

Headings of sections provided in this patent application and the title of this patent application are for convenience only and are not to be taken as limiting the disclosure in any way.

A description of an embodiment with several components in connection with each other does not imply that all such components are required. To the contrary, a variety of optional components may be described to illustrate a wide variety of possible embodiments of one or more of the inventions and in order to more fully illustrate one or more aspects of the inventions.

Materials described or referenced herein will sometimes be described in singular form for clarity. However, it should be appreciated that particular embodiments may include multiple instantiations of a material unless noted otherwise. Layers in some embodiments can be understood as representing segments or portions of those embodiments. Alternate implementations are included within the scope of embodiments of the present invention would be understood by those having ordinary skill in the art.

### Definitions

Portable vinyl partition refers to an apparatus that is designed to be removeable and used in various sized vehicles to form a partition within a vehicle. The portable partition is installed vertically behind the front seats of a vehicle. Once installed the dihedral partition will have the effect of dividing the vehicle into two sections but also allows for sound to travel.

In an embodiment, the Bioshield is designed to provide a unique and novel manner for a user to mitigate the spread of viruses. The embodiment is designed with an exposed frame structure (6) that is designed to apply some rigidity to the embodiment in a manner to allow for strength and support upon installation. The exposed frame is held together by a plurality of attachment couplings (5) to provide support for the frame. The user can place the embodiment into a number of various size vehicles by carefully installing the outer structure right side up along the rear of the front seats and along the pillars (18) of the vehicle. In essence, the user will insert the partition conveniently behind the front seats in a manner where the partition is contiguous against the rear surface of the front seats. The partition will extend vertically from the floor to the roof of the vehicle and horizontally from the left 18(A) to right side 18(B) pillars. The body will be designed of transparent vinyl material to allow for visibility between the front and rear seats once installed but mitigates the transmission of bodily particulates.

In an embodiment, the Bioshield is an apparatus that is made of vinyl that is installed in a vehicle with the intent to help mitigate spread of bodily fluids particulates. Once installed, a user will feel confident that the embodiment will greatly assist with mitigating pathogens. To fully complete the installation a user will need to ensure that all inlet openings (1) along the partition fits certain features of the vehicle such as the rear vents. The partition is comprised of a body (2) that is shaped in a fashion to separate the front and rear compartments of a vehicle by fitting the side edges, bottom edge (16), and top edge (13) of the embodiment in a manner where the outer foam edges (9) of the partition is in contact with the interior surfaces of the vehicle such as the floor, roof and pillar (18) surfaces. The foam outer edges (9) of the partition are ideal because they act to provide a snug fit while providing rigidity once the partition is installed. To illustrate, the foam edges (9) should be applied to an area between the pillars (18) and the peripheral of the far left and right seat head rests (19). The embodiment is designed in a way that allows the user to apply a plurality of straps to an attachment point inside the vehicle where the partition will be secured. In a non-limiting example, the embodiment comes complete with at least one strap for installation purposes that will be applied at various points within the vehicle to ensure that the portable partition is securely installed. In fact, in some areas of the vehicle it will become necessary to describe the straps as a set versus a single strap as a reference. For instance, the first set of attachment straps (7) will be utilized to attach at both the left and right door jams while the vehicle doors are in the open position but will allow the doors to close without obstruction. The second set of attachment straps (8) will be installed at the upper portion of the exposed frame structure (6) contiguous to the head rests. The third set of attachment straps (10) will be installed around attachment points under both the left and right set of front seats. The fourth set of attachment straps (11) will be attached to the lower portion of the exposed frame structure (6). A first single attachment strap (3) will be attached to the upper portion of the exposed frame structure (6) to provide lateral support. A second single attachment strap (4) that is attached along the center bottom portion of the exposed frame structure (6). The contact surface of the partition will be secured flush against the seats once the embodiment is installed against the rear surface of the front seats. All attachment straps will use a hook and loop fastener but is not limited to this example and may implement any suitable attachment. Upon installation of the partition, the user can simply relax and enjoy the ride knowing that there is a level of protection between the front and rear compartments for minimizing risk associated with the spread of contagions. The experience of encountering others can be discerning experience during times where viral infections are on the rise. Most patrons will take precautions by wearing face shields etc. but having an added protection will provide relief for customers utilizing public vehicles and increase business for commercial services such as an app driving platforms and similar companies. This concept will provide a sense of freedom and mobility to individuals who find it necessary to use such services for business and personal reasons. The use of this apparatus does not preclude or infer that a passenger should not use additional precautions such as wearing a protective face covering.

In a non-limiting example, the embodiment may be designed in various widths and lengths to accommodate varying sized vehicles. For instance, where a user has a large sized vehicle, the user can select a suitable sized partition. It will be appreciated that the embodiment can be designed for different types of vehicles such as trains, planes, buses and the like but is not limited to these examples as additional modes of travel may become apparent in the future.

Additionally, in a nonlimiting example, the portable partition can be designed in various colors and designs.

### Exemplary Embodiments

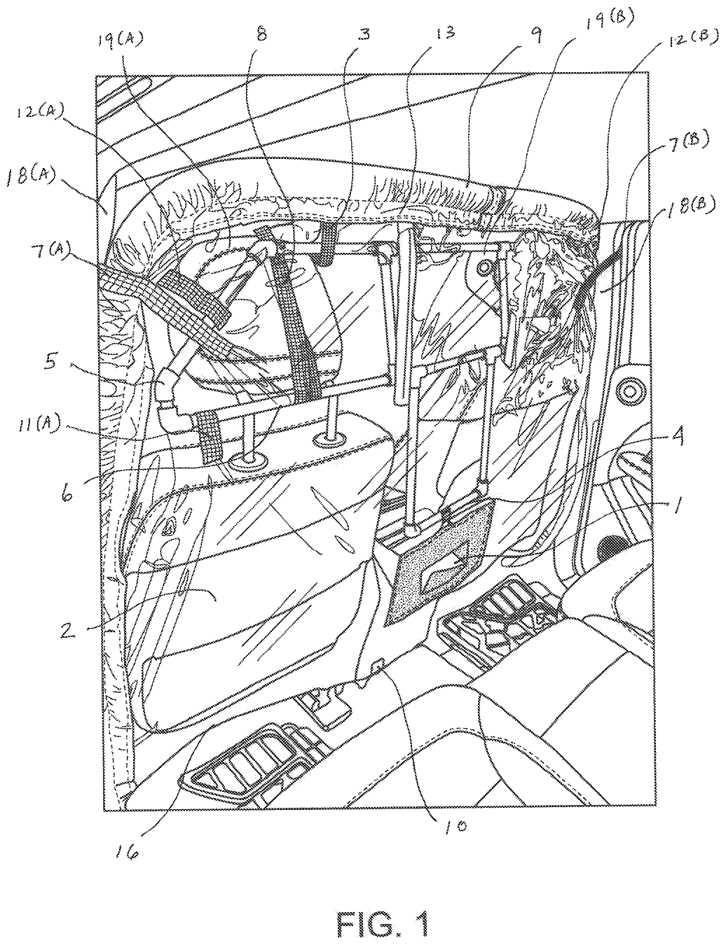

FIG. 1 is a perspective left-side angle view from a vehicle's rear seat of a portable partition for conveniently forming a partition, according to a preferred embodiment of the invention. According to the embodiment a partition comprises top edge (13), left side edge (15), a plurality of attachment couplings (5), an inlet opening (1), a body (2) comprising a transparent vinyl surface, an attachment strap along the center bottom portion of the exposed frame structure (4), and an upper exposed frame structure (6). The upper portion of the exposed frame structure (6) is securely held in position by a fifth set of attachment straps (11) extending from the top edge (13) of the apparatus in a vertical fashion. In a non-limiting example, the adjoining straps can be manufactured in any preferred material, texture, or color that will be suitable for the user. The lower portion of the exposed frame structure (6) is held in position by a sixth set of attachment straps (12). The schematic shows a first set of attachment straps (7), a second set of attachment straps (8) affixed to the upper portion of the exposed frame structure (6). The partition is also held in position via the fourth set of attachment straps (10). A first single attachment strap (3) is shown that is applied to the center upper portion of the exposed frame structure (6) to provide lateral support. The figure also depicts a left side pillar indicated as 18(A) and a right side pillar indicated as 18(B). The figure further depicts a left seat head rest indicated as 19(A) and a right side head rest indicated as 19(B). It should be appreciated that the size and shape of the portable partition can be designed in a particular shape to conveniently fit into a passenger transport vehicle.

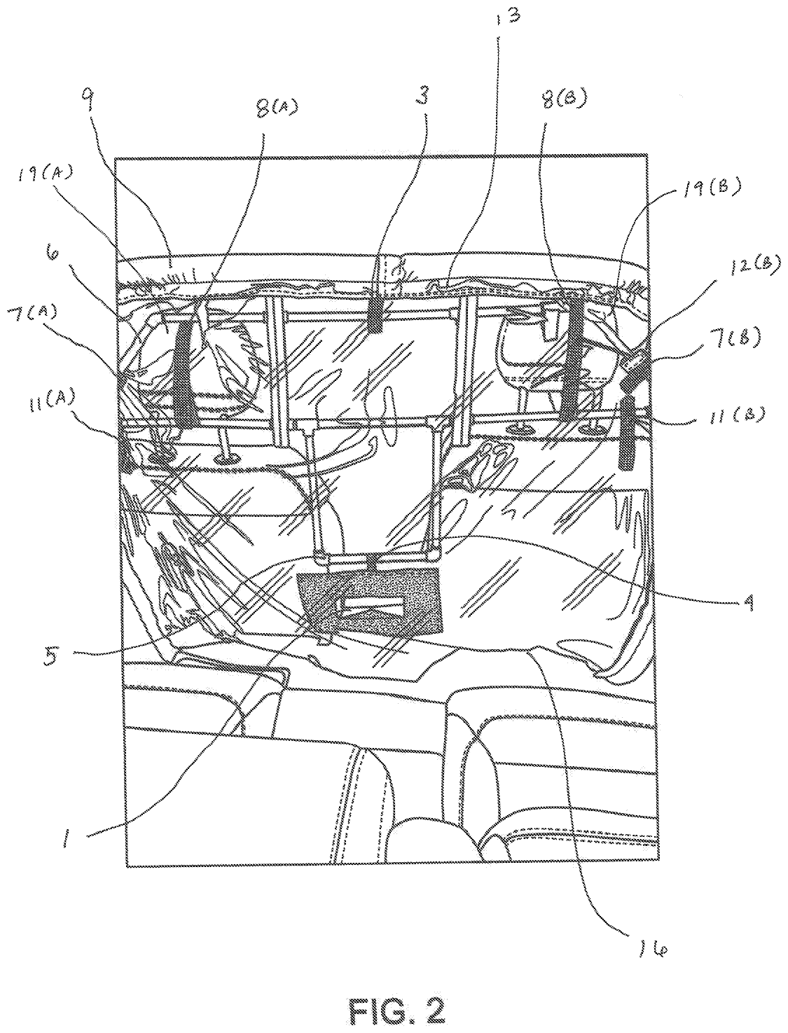

FIG. 2 is a perspective view from a vehicle's rear seat of a portable partition for conveniently forming a partition, according to a preferred embodiment of the invention. The schematics shows, the top edge (13), a bottom edge (16), the fifth set of attachment straps (11) secured to the upper portion of the exposed frame structure (6). The image also shows foam outer edge (9) and is allows connecting fifth set of attachment straps (11) to extend vertically. The schematic shows a first set of attachment straps (7), second set of attachment straps (8), and a sixth attachment strap (12) positioned along the top portion of the exposed frame structure (6) to support the embodiment. Additionally, attachment strap (3) is shown that is applied to the center upper portion of the exposed frame structure (6) to provide lateral support. The attachment strap (4) is positioned along the center bottom portion of the exposed frame structure (6). Also, the drawing shows the inlet opening (1) and a plurality of attachment couplings (5) that acts as support for the exposed frame structure (6). The figure further depicts a left seat head rest indicated as 19(A) and a right side head rest indicated as 19(B).

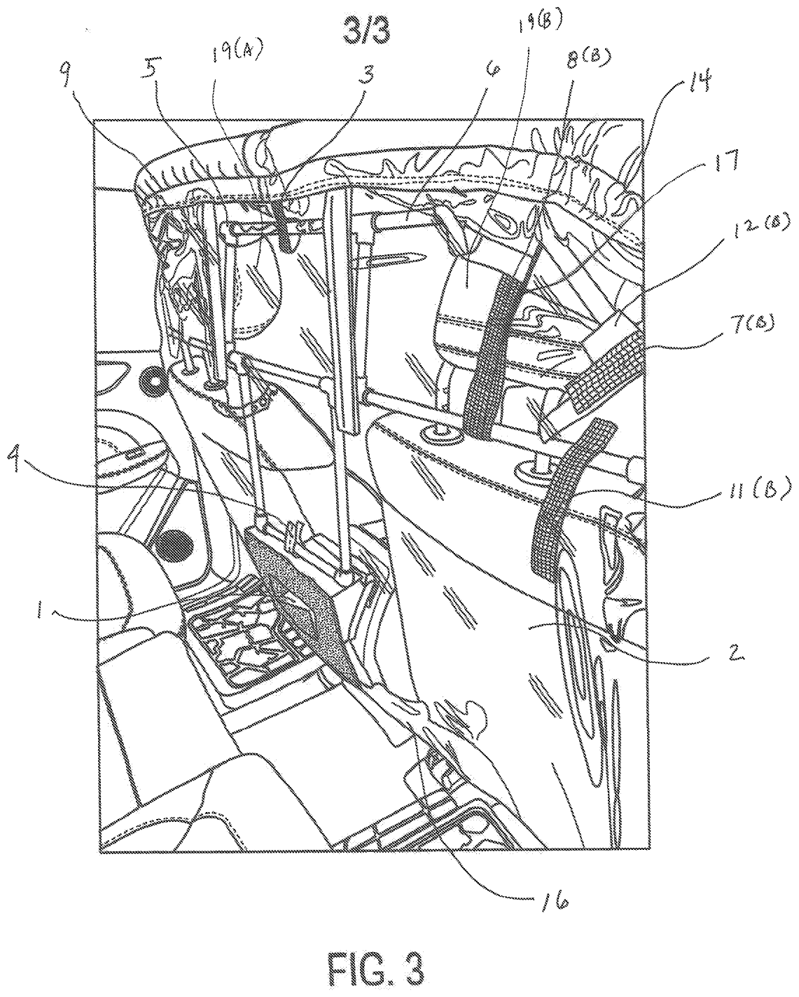

FIG. 3 is a perspective right-side angle view from a vehicle's rear seat of a portable partition for conveniently forming a partition for a vehicle compartment, according to a preferred embodiment of the invention. The schematic shows, the top edge (13), a right side edge (14), a plurality of attachment couplings (5) that acts as support for the exposed frame structure (6). The partition is shown attached to the lower portion of the exposed frame structure (6) by an attachment strap 8(B) held secure by a hook and loop fastener (17), as well as an attachment strap 7(B) that extends to the door jam, and a second single attachment strap (4) that is attached along the center bottom portion of the exposed frame structure (6). The schematic further depicts an inlet (1) and a first single attachment strap (3) that is attached at a point that is along the top edge (13) of the transparent body (2) of the embodiment. The schematic also shows the foam outer edge (9) of the embodiment and an attachment 12(B). The figure depicts an attachment strap 11(B) extending from the top edge (13) of the exposed frame structure (6). Lastly, the figure further depicts a left seat head rest indicated as 19(A) and a right side head rest indicated as 19(B).

The skilled person will be aware of a range of possible modifications of the various embodiments described above. Accordingly, the present invention is defined by the claims and their equivalents.

What is claimed is:

1. A portable partition comprising:
a body, a bottom edge, a top edge, a left side edge, a right side edge, an exposed frame structure, at least one attachment strap, and an outer foam cover.

2. The portable partition of claim 1 wherein said body is comprised of transparent vinyl material.

3. The portable partition of claim 1 wherein said body is comprised of at least one inlet opening.

4. The portable partition of claim 1 wherein said bottom edge is comprised of adjoining said first set of attachment straps.

5. The portable partition of claim 4 wherein said first set of attachment straps further includes a hook and loop fastener.

6. The portable partition of claim 1 wherein said top edge is comprised of adjoining said second set of attachment straps.

7. The portable partition of claim 6 wherein said second set of attachment straps further includes a hook and loop fastener.

8. The portable partition of claim 1 wherein said left side edge is comprised of adjoining said third set of attachment straps.

9. The portable partition of claim 8 wherein said third set of attachment straps further includes a hook and loop fastener.

10. The portable partition of claim 1 wherein said right side edge is comprised of adjoining said fourth set of attachment straps.

11. The portable partition of claim 10 wherein said fourth set of attachment straps further includes a hook and loop.

12. The portable partition of claim 1 wherein said exposed frame structure comprises a support fixture positioned in a contiguous fashion along the upper portion of the partition.

13. The portable partition of claim 12 wherein said exposed frame structure further comprises a plurality of attachment couplings.

14. The portable partition of claim 1 wherein said outer foam cover encases the portion of said exposed frame structure that forms the peripheral edge of the portable partition.

15. The portable partition of claim 1 wherein said top edge is comprised of an adjoining first single attachment strap.

16. The portable partition of claim 15 wherein said first single attachment strap further includes a hook and loop fastener.

17. The portable partition of claim 1 wherein said bottom edge is comprised of an adjoining second single attachment strap.

18. The portable partition of claim 17 wherein said second single attachment strap further includes a hook and loop fastener.
